(19) United States
(12) Patent Application Publication
(10) Pub. No.: US 2024/0302702 A1
(43) Pub. Date: Sep. 12, 2024

(54) ARRAY SUBSTRATE AND DISPLAY PANEL

(71) Applicant: Guangzhou China Star Optoelectronics Semiconductor Display Technology Co., LTD., Guangzhou, Guangdong (CN)

(72) Inventor: Yuan SHAO, Guangzhou, Guangdong (CN)

(73) Assignee: Guangzhou China Star Optoelectronics Semiconductor Display Technology Co., LTD., Guangzhou, Guangdong (CN)

(21) Appl. No.: 17/781,005

(22) PCT Filed: May 23, 2022
(86) PCT No.: PCT/CN2022/094421

§ 371 Date: May 30, 2022

(30) Foreign Application Priority Data
May 10, 2022 (CN) 202210506053.5

(51) Int. Cl. G02F 1/1362

(52) U.S. Cl. CPC G02F 1/13629; G02F 1/136222

(57) ABSTRACT

An array substrate and a display panel are disposed. The array substrate includes a base substrate, a first conductive layer, an insulating layer, and a second conductive layer arranged in sequence. A groove is formed on the base substrate, and the first conductive layer includes a first conductive trace at least partially located in the groove. The second conductive layer includes a second conductive trace arranged at an angle and overlapping with the first conductive trace. This can reduce a climbing height and reduce a risk of breakage of the second conductive trace.

### FIELD OF THE DISCLOSURE

The present application relates to the technical field of display, and more particularly, to an array substrate and a display panel.

### BACKGROUND

With the development of display technologies, requirements of display products for pixels and refresh rates are constantly increasing. In the prior art, in order to meet refresh rates and response time of new products, a film thickness of a conductive layer is often increased to increase an electrical conductivity of a metal trace. However, as a thickness of a metal film increases, a probability of disconnection of the metal trace at a climbing position also increases, thereby affecting a display performance.

### SUMMARY

### Technical Problem

Embodiments of the present application provide an array substrate and a display panel, which can solve an issue of easy disconnection of a metal trace in a current array substrate.

### Technical Solution

Embodiments of the present application provide an array substrate comprising:
a base substrate, wherein the base substrate is provided with a groove, and the groove extends along a first direction;
a first conductive layer disposed on a surface of the base substrate, wherein the first conductive layer comprises a first conductive trace, the first conductive trace is at least partially located in the groove, and the first conductive trace extends along the first direction;
an insulating layer disposed on a surface of the first conductive layer away from the base substrate;
a second conductive layer disposed on a surface of the insulating layer away from the first conductive layer, wherein the second conductive layer comprises a second conductive trace, and the second conductive trace extends along a second direction; wherein the second direction forms an included angle with the first direction; wherein the second conductive trace and the first conductive trace is arranged overlappingly.

Optionally, in some embodiments of the present application, the base substrate is provided with a plurality of grooves, the grooves are arranged side by side along the second direction; wherein the first conductive layer comprises a plurality of first conductive traces, and the first conductive traces are arranged in a one-to-one correspondence with the grooves.

Optionally, in some embodiments of the present application, the second conductive layer comprises a plurality of the second conductive traces, and the second conductive traces are arranged in parallel along the first direction.

Optionally, in some embodiments of the present application, the first conductive trace comprises a scan line, and the second conductive trace comprises a data line.

Optionally, in some embodiments of the present application, the first conductive trace is all located in the groove; wherein an absolute value of a difference between a thickness of the first conductive trace and a depth of the groove is smaller than a thickness of the first conductive trace.

Optionally, in some embodiments of the present application, a surface of the first conductive trace is flush with the surface of the base substrate.

Optionally, in some embodiments of the present application, a depth of the groove is less than or equal to 15000 angstroms; wherein a width of the groove in the second direction is less than or equal to 100 microns.

Optionally, in some embodiments of the present application, a thickness of the second conductive trace is less than or equal to 15000 angstroms; wherein a width of the second conductive trace in the first direction is less than or equal to 100 microns.

Optionally, in some embodiments of the present application, one of the second conductive traces comprises a first body, a second body, and a reinforcement part, the first body is located between two adjacent first conductive traces, the second body is stacked on one of the first conductive trace, and the reinforcement part is connected between the first body and the second body; wherein in the first direction, a width of the reinforcement part is greater than a width of the first body.

Optionally, in some embodiments of the present application, in the first direction, the reinforcement part protrudes from opposite sides of the first body.

Optionally, in some embodiments of the present application, the width of the reinforcement part is greater than or equal to 1.1 times the width of the first body and less than or equal to 6 times the width of the first body.

Optionally, in some embodiments of the present application, a material of the first conductive traces is same as a material of the second conductive traces; wherein the material of the first conductive traces comprises one or more of molybdenum, aluminum, and copper.

Correspondingly, an embodiment of the present application further provides a display panel, the display panel comprises an array substrate and a display component; wherein the array substrate comprises:
a base substrate, wherein the base substrate is provided with a groove, and the groove extends along a first direction;
a first conductive layer disposed on a surface of the base substrate, wherein the first conductive layer comprises a first conductive trace, the first conductive trace is at least partially located in the groove, and the first conductive trace extends along the first direction; an insulating layer disposed on a surface of the first conductive layer away from the base substrate;
a second conductive layer disposed on a surface of the insulating layer away from the first conductive layer, wherein the second conductive layer comprises a second conductive trace, and the second conductive trace extends along a second direction; wherein the second direction forms an included angle with the first direction; wherein the second conductive trace and the first conductive trace is arranged overlappingly;
wherein the display component is located on a side of the second conductive layer away from the base substrate.

Optionally, in some embodiments of the present application, the base substrate is provided with a plurality of grooves, the grooves are arranged side by side along the second direction; wherein the first conductive layer comprises a plurality of first conductive traces, and the first conductive traces are arranged in a one-to-one correspondence with the grooves.

Optionally, in some embodiments of the present application, the second conductive layer comprises a plurality of the second conductive traces, and the second conductive traces are arranged in parallel along the first direction.

Optionally, in some embodiments of the present application, the first conductive trace is all located in the groove; wherein an absolute value of a difference between a thickness of the first conductive trace and a depth of the groove is smaller than a thickness of the first conductive trace.

Optionally, in some embodiments of the present application, a depth of the groove is less than or equal to 15000 angstroms; wherein a width of the groove in the second direction is less than or equal to 100 microns.

Optionally, in some embodiments of the present application, one of the second conductive traces comprises a first body, a second body, and a reinforcement part, the first body is located between two adjacent first conductive traces, the second body is stacked on one of the first conductive trace, and the reinforcement part is connected between the first body and the second body; wherein in the first direction, a width of the reinforcement part is greater than a width of the first body.

Optionally, in some embodiments of the present application, the display component comprises a light emitting device and a package assembly, the light emitting device is located on a side of the second conductive layer away from the base substrate, and the light emitting device is electrically connected to the array substrate; wherein the package assembly is located on a side of the light emitting device away from the array substrate.

Optionally, in some embodiments of the present application, the display component comprises a color filter substrate and a liquid crystal layer, the color filter substrate is located on a side of the second conductive layer away from the base substrate, and the liquid crystal layer is filled between the color filter substrate and the array substrate.

### Beneficial Effect

In the embodiments of the present application, the array substrate includes a base substrate, a first conductive layer, an insulating layer, and a second conductive layer. A groove is formed on the base substrate, and the groove extends along the first direction. The first conductive layer is disposed on a surface of the base substrate. The first conductive layer includes a first conductive trace, the first conductive trace is at least partially located in the groove, and the first conductive trace extends along a first direction. The insulating layer is arranged on a surface of the first conductive layer away from the base substrate. The second conductive layer is disposed on a surface of the insulating layer away from the first conductive layer. The second conductive layer includes a second conductive trace, the second conductive trace extends along a second direction, and the second direction forms an included angle with the first direction. The second conductive trace and the first conductive trace are arranged overlappingly. The present application can reduce a height difference of the first conductive traces relative to the base substrate by forming grooves on the base substrate, and at least partially disposing the first conductive traces in the grooves. This reduces a climbing height corresponding to an overlapping position of the second conductive trace and the first conductive trace when forming the second conductive trace overlapping with the first conductive trace, thereby reducing a risk of breakage of the second conductive trace.

### BRIEF DESCRIPTION OF THE DRAWINGS

In order to illustrate the technical solutions in the embodiments of the present application more clearly, the following briefly introduces the accompanying drawings that are used in the description of the embodiments. Obviously, the drawings in the following description are only some embodiments of the present application. For those skilled in the art, other drawings can also be obtained from these drawings without creative effort.

FIG. 1 is a schematic structural diagram of an array substrate provided by an embodiment of the present application.

FIG. 2 is a schematic structural diagram of another array substrate provided by an embodiment of the present application.

FIG. 3 is a schematic structural diagram of a display panel provided by an embodiment of the present application.

FIG. 4 is a schematic structural diagram of another display panel provided by an embodiment of the present application.

FIG. 5 is a flowchart of a method for fabricating an array substrate provided by an embodiment of the present application.

FIG. 6 is a schematic structural diagram of step S100 in FIG. 5 provided by an embodiment of the present application.

FIG. 7 is a schematic structural diagram of step S300 in FIG. 5 provided by an embodiment of the present application.

FIG. 8 is another schematic structural diagram of step S300 in FIG. 5 provided by an embodiment of the present application.

FIG. 9 is a flowchart of step S600 in FIG. 5 provided by an embodiment of the present application.

FIG. 10 is a schematic structural diagram of step S650 in FIG. 9 provided by an embodiment of the present application.

FIG. 11 is another schematic structural diagram of step S650 in FIG. 9 provided by an embodiment of the present application.

FIG. 12 is a schematic structural diagram of a mask provided by an embodiment of the present application.

### DESCRIPTION OF REFERENCE NUMBERS

| Reference | | Reference | |
|---|---|---|---|
| Number | Part Name | Number | Part Name |
| 10 | display panel | 1413 | reinforcement part |
| 100 | array substrate | X | first direction |
| 110 | base substrate | Y | second direction |
| 111 | groove | 200 | mask |
| 120 | first conductive layer | 210 | first shielding part |
| 121 | first conductive trace | 220 | second shielding part |
| 130 | insulating layer | 300 | display component |
| 140 | second conductive layer | 310 | light emitting device |
| 141 | second conductive trace | 320 | package assembly |
| 1411 | first body | 330 | color filter substrate |
| 1412 | second body | 340 | liquid crystal layer |

### DETAILED DESCRIPTION

The technical solutions in the embodiments of the present application will be clearly and completely described below with reference to the accompanying drawings in the embodiments of the present application. Obviously, the described embodiments are only a part of the embodiments of the present application, but not all of the embodiments. Based on the embodiments in the present application, all other embodiments obtained by those skilled in the art without creative work fall within the protection scope of the present application. In addition, it should be understood that the specific embodiments described herein are only used to illustrate and explain the present application, but not to limit the present application. In this application, unless otherwise stated, the directional words used such as “upper” and “lower” generally refer to upper and lower sides of the device in actual use or working state, specifically the drawing direction in the accompanying drawings, and “inside” and “outside” refer to the outline of the device.

Embodiments of the present application provide an array substrate, a display panel, and a method for fabricating the array substrate. Each of them will be described in detail below. It should be noted that the description order of the following embodiments is not intended to limit the preferred order of the embodiments.

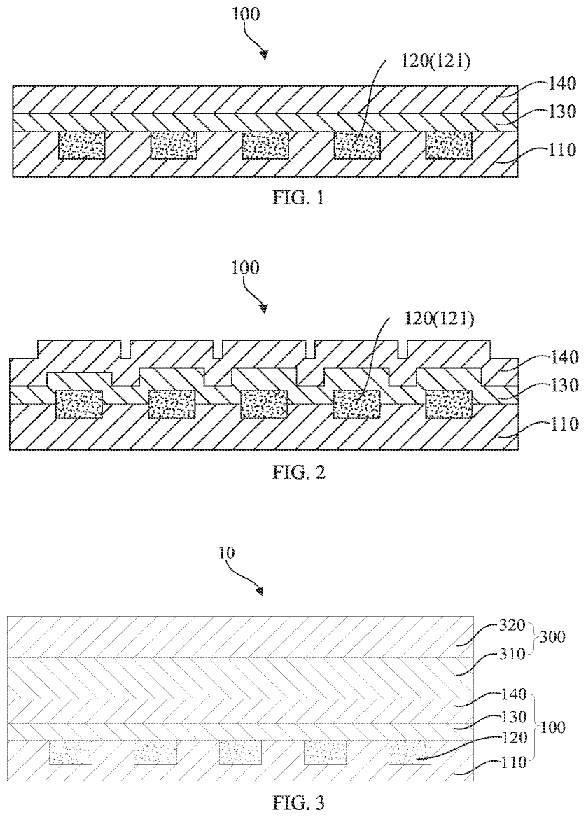

First, an embodiment of the present application provides an array substrate. As shown in FIG. 1 and FIG. 2, the array substrate 100 includes a base substrate 110. The base substrate 110 is used as a support structure for the array substrate 100 to support other structures on the array substrate 100 to ensure a structural stability of the array substrate 100.

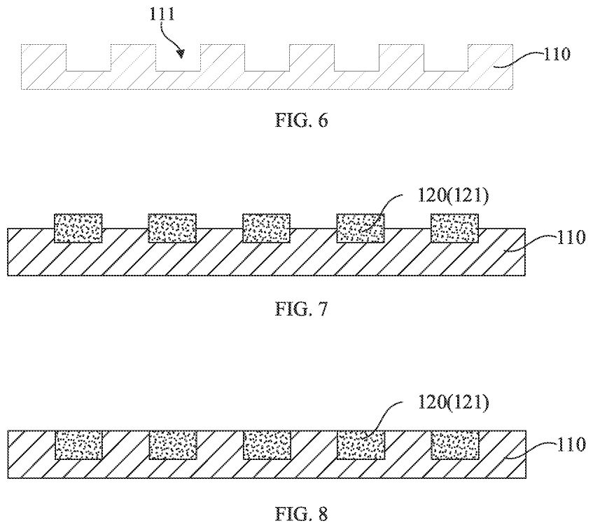

As shown in FIG. 6 and FIG. 10, a groove 111 is formed on the base substrate 110, and the groove 111 extends along the first direction X. By forming the grooves 111 on the base substrate 110, when the subsequent film layers are fabricated on the base substrate 110, the subsequent film layer can be arranged in the grooves 111. This reduces a height difference between the subsequent film layer and the base substrate 110.

As shown in FIG. 7 and FIG. 8, the array substrate 100 includes a first conductive layer 120. The first conductive layer 120 is provided on the surface of the base substrate 110. The first conductive layer 120 includes a first conductive trace 121, and the first conductive trace 121 is at least partially located in the groove 111. By arranging the first conductive traces 121 at least partially in the grooves 111 of the base substrate 110, the height of the first conductive traces 121 relative to the base substrate 110 is smaller than the thickness of the first conductive traces 121. Thus, the height difference caused by the first conductive traces 121 is reduced. The first conductive traces 121 extend along the first direction X. That is, the first conductive traces 121 are filled in the grooves 111, so that the arrangement of the grooves 111 has a positioning effect on the first conductive traces 121. This is beneficial to improve the structural stability of the first conductive traces 121 relative to the base substrate 110.

As shown in FIG. 10 and FIG. 11, the array substrate 100 includes a second conductive layer 140. The second conductive layer 140 is disposed on a surface of the insulating layer 130 away from the first conductive layer 120. The second conductive layer 140 includes second conductive traces 141. The second conductive traces 141 extend along the second direction Y. The second direction Y and the first direction X form an included angle, and the second conductive traces 141 and the first conductive traces 121 are arranged to overlap. That is, the first conductive traces 121 and the second conductive traces 141 cross each other in the extending direction, and the first conductive traces 121 and the second conductive traces 141 partially overlap.

As shown in FIG. 2, when the first conductive trace 121 is partially located in the groove 111, there is a height difference between the first conductive trace 121 and the base substrate 110. That is, the first conductive trace 121 protrudes from the surface of the base substrate 110. Since the insulating layer 130 is uniformly deposited on the first conductive layer 120, that is, the thickness of the insulating layer 130 is relatively uniform, so that there is a height difference between the part of the insulating layer 130 covering the first conductive trace 121 and the part of the insulating layer 130 not covering the first conductive trace 121. When the second conductive traces 141 are formed on the insulating layer 130, there is an climbing area where the second conductive traces 141 and the first conductive traces 121 overlap. If the climbing height is large, the second conductive trace 141 will be broken. By adjusting the depth of the grooves 111 on the base substrate 110, the height difference caused by the first conductive traces 121 can be effectively reduced. Therefore, the climbing height of the climbing area where the second conductive trace 141 and the first conductive trace 121 overlap is reduced, thereby reducing the risk of fracture of the second conductive trace 141.

In the array substrate 100 in the embodiment of the present application, the grooves 111 are formed on the base substrate 110, and the first conductive traces 121 are at least partially arranged in the grooves 111, so that a height difference between the first conductive trace 121 and the base substrate 110 can be reduced. This reduces the climbing height corresponding to the overlapping position of the second conductive trace 141 and the first conductive trace 121 when forming the second conductive trace 141 disposed overlapping the first conductive trace 121. Thus, the risk of fracture of the second conductive trace 141 is reduced.

Optionally, a plurality of grooves 111 are formed on the base substrate 110. The plurality of grooves 111 are arranged in parallel along the second direction Y. The first conductive layer 120 includes a plurality of first conductive traces 121. The first conductive traces 121 are arranged in a one-to-one correspondence with the grooves 111. That is, when the base substrate 110 is fabricated, the grooves 111 are formed on the base substrate 110 at positions corresponding to the first conductive traces 121 according to the disposition requirements of the first conductive traces 121. This enables the first conductive traces 121 to be located in the grooves 111.

The distribution direction of the plurality of first conductive traces 121 is consistent with the extending direction of the second conductive traces 141. That is, the second conductive traces 141 are disposed to overlap with the plurality of first conductive traces 121.

The second conductive traces 141 and each of the first conductive traces 121 form a climbing area at the overlap. By arranging the plurality of first conductive traces 121 and the plurality of grooves 111 in one-to-one correspondence, the climbing height of the climbing area formed by the second conductive traces 141 and each of the first conductive traces 121 can be reduced. Thus, the risk of fracture of the second conductive trace 141 in any climbing area is reduced.

Optionally, the second conductive layer 140 includes a plurality of second conductive traces 141. The plurality of second conductive traces 141 are arranged in parallel along the first direction X. That is, the distribution direction of the plurality of second conductive traces 141 is consistent with the extending direction of the first conductive traces 121. This makes each of the second conductive traces 141 overlap with the plurality of first conductive traces 121. Because the extending direction of the first conductive trace 121 is consistent with the extending direction of the groove 111, this enables the first conductive traces 121 to be at least partially filled in the grooves 111. That is, the climbing height of the climbing area formed at the overlap of each second conductive trace 141 and the plurality of first conductive traces 121 can be effectively reduced. Thus, the risk of fracture of the plurality of second conductive traces 141 as a whole is reduced.

It should be noted that the first conductive traces 121 can be scan lines in the array substrate 100. The second conductive traces 141 can be data lines. The plurality of first conductive traces 121 and the plurality of second conductive traces 141 form a grid structure.

That is, a plurality of scan lines and a plurality of data lines form a grid structure. The array substrate 100 includes a thin film transistor layer. The scan lines and the data lines are used for electrical connection with the thin film transistors in the thin film transistor layer to control the on or off of the corresponding thin film transistors. By forming a plurality of scan lines and a plurality of data lines into a grid structure, the circuit design between the scan lines and the data lines and the thin film transistor layer is facilitated. This is beneficial to simplify the trace structure in the array substrate 100 and improve a production efficiency.

In some embodiments, as shown in FIG. 8, the first conductive traces 121 are all located in the grooves 111, and the surfaces of the first conductive traces 121 are flush with the surface of the base substrate 110. That is, the height of the first conductive traces 121 is equal to the height of the base substrate 110. Such a structural design can further reduce the height difference caused by the first conductive traces 121, and this enables the surface of the insulating layer 130 to be kept flat when the insulating layer 130 is formed on the first conductive layer 120. Therefore, the surfaces of the second conductive traces 141 are also kept flat. There is no climbing area where the second conductive trace 141 and the first conductive trace 121 overlap, the risk of the second conductive trace 141 being broken is reduced to the greatest extent.

In still other embodiments, all the first conductive traces 121 are located in the grooves 111, and the surfaces of the first conductive traces 121 are lower than the surface of the base substrate 110. The absolute value of the difference between the thickness of the first conductive trace 121 and the depth of the groove 111 on the base substrate 110 is smaller than the thickness of the first conductive trace 121. This makes the height difference between the first conductive trace 121 and the base substrate 110 smaller than the thickness of the first conductive trace 121 itself. Such a structural design can still reduce the height difference caused by the first conductive trace 121 and reduce the risk of fracture of the second conductive trace 141. The overlapping part of the insulating layer 130, the second conductive trace 141, and the first conductive trace 121 is a recessed structure relative to the base substrate 110, which also helps to reduce the overall thickness of the array substrate 100.

Optionally, the depth of the groove 111 is less than or equal to 15000 angstroms. The absolute value of the difference between the thickness of the first conductive trace 121 and the depth of the groove 111 is smaller than the thickness of the first conductive trace 121. During the manufacturing process of the array substrate 100, as long as the grooves 111 are formed on the base substrate 110 so that the first conductive traces 121 are partially located in the grooves 111, the height difference caused by the first conductive traces 121 can be reduced. This reduces the climbing height of the climbing area where the second conductive trace 141 and the first conductive trace 121 overlap, thereby reducing the risk of fracture of the second conductive trace 141. If the depth of the grooves 111 is too large, when the first conductive traces 121 are arranged in the grooves 111, although the first conductive traces 121 are all located in the grooves 111, the surface is lower than the surface of the base substrate 110, and the height difference between the first conductive trace 121 and the base substrate 110 is greater than the thickness of the first conductive trace 121 itself, such that the purpose of reducing the climbing height of the climbing area cannot be achieved. In addition, the thickness of the base substrate 110 is too large, which in turn leads to an increase in the overall weight of the array substrate 100.

In the actual fabrication process, the depth of the groove 111 can be set to 100 angstroms, 1000 angstroms, 5000 angstroms, 10000 angstroms, or 15000 angstroms. This can not only ensure that the setting of the groove 111 can effectively reduce the climbing height of the climbing area where the second conductive trace 141 and the first conductive trace 121 overlap, prevent the second conductive trace 141 from breaking, and also prevent the base substrate 110 from being too thick, which may result in an increase in the overall weight of the array substrate 100. The specific depth value of the groove 111 can be adjusted according to actual design requirements and the thickness of the first conductive trace 121, which is not limited herein.

Optionally, the width of the groove 111 in the second direction Y is less than or equal to 100 microns. That is, the width of the first conductive traces 121 located in the grooves 111 in the second direction Y is less than or equal to 100 microns. If the width of the groove 111 in the second direction Y is too large, under the condition that a certain number of first conductive traces 121 are arranged in a certain area, the distance between two adjacent first conductive traces 121 will be too small. During the fabrication or use of the array substrate 100, mutual interference between two adjacent first conductive traces 121 may occur, which affects the normal use of the array substrate 100.

In the actual manufacturing process, the width of the groove 111 in the second direction Y can be set to 10 micrometers, 20 micrometers, 50 micrometers, 80 micrometers, or 100 micrometers or the like. This can not only ensure that the first conductive traces 121 have a sufficient width, reduce the internal resistance of the first conductive traces 121, but also avoid mutual interference between two adjacent first conductive traces 121 due to too small spacing. The specific value of the width of the groove 111 in the second direction Y can be adjusted according to actual design requirements, and no special limitation is made here.

When the surface of the first conductive trace 121 is flush with the surface of the base substrate 110, the depth and width of the groove 111 are the thickness and width of the first conductive trace 121. In the embodiment of the present application, the thickness and width of the second conductive trace 141 can be consistent with the thickness and width of the first conductive trace 121. That is, the thickness of the second conductive traces 141 is less than or equal to 15000 angstroms, and the width of the second conductive traces 141 in the first direction X is less than or equal to 100 microns, and the specific conditions are not repeated here.

Optionally, as shown in FIG. 10 and FIG. 11, in the embodiment of the present application, the second conductive trace 141 includes a first body 1411, a second body 1412, and a reinforcement part 1413. The first body 1411 is located between two adjacent first conductive traces 121. The second body 1412 is stacked on the first conductive traces 121. The reinforcement part 1413 is connected between the first body 1411 and the second body 1412. That is, the first body 1411, the reinforcement part 1413, and the second body 1412 together form the second conductive traces 141 extending along the second direction Y. The reinforcement part 1413 corresponds to the climbing area where the second conductive trace 141 and the first conductive trace 121 overlap.

In the first direction X, the width of the reinforcement part 1413 is greater than the width of the first body 1411. That is, the width of the second conductive trace 141 corresponding to the climbing area is greater than the width of the first body 1411 where the second conductive trace 141 is located between two adjacent first conductive traces 121.

Since the second conductive trace 141 has a climbing height at the position corresponding to the climbing area, when the second conductive layer 140 is patterned to form the second conductive trace 141, it is easier to form over etching at the position corresponding to the climbing area. As a result, the second conductive trace 141 is broken in the climbing area. By setting the width of the reinforcement part 1413 to be larger than the width of the first body 1411, a part for over etching can be reserved on the reinforcement part 1413. Therefore, the risk of fracture at the position of the second conductive trace 141 corresponding to the climbing area due to over etching can be effectively prevented.

In some embodiments, in the first direction X, the reinforcement parts 1413 protrude from opposite sides of the first body 1411. That is, in the first direction X, opposite sides of the reinforcement part 1413 are wider than opposite sides of the first body 1411. Therefore, the reinforcement part 1413 can protect both opposite sides of the second conductive trace 141 corresponding to the climbing area. The risk of fracture at the position of the second conductive trace 141 corresponding to the climbing area due to over etching is prevented.

Optionally, the width of the reinforcement part 1413 is greater than or equal to 1.1 times the width of the first body 1411 and less than or equal to 6 times the width of the first body 1411. That is, the width of the reinforcement part 1413 protruding from the first body 1411 is greater than or equal to 0.1 times the width of the first body 1411 and less than or equal to 5 times the width of the first body 1411. If the width of the reinforcement part 1413 relative to the first body 1411 is too small, the reinforcement part 1413 cannot effectively prevent over etching. If the width of the reinforcement part 1413 relative to the first body 1411 is too large, the distance between two adjacent second conductive traces 141 will be too small, and as a result, mutual interference is likely to occur between two adjacent second conductive traces 141.

In the actual manufacturing process, the width of the reinforcement part 1413 can be set to be 1.1 times, 2 times, 3 times, 4 times, 5 times, or 6 times the width of the first body 1411. This can not only ensure that the reinforcement part 1413 can effectively prevent the over etching of the second conductive trace 141 corresponding to the climbing area, but also prevent the occurrence of crosstalk between two adjacent second conductive traces 141 due to a small distance. The specific value of the width of the reinforcement part 1413 relative to the first body 1411 can be adjusted according to actual design requirements, which is not limited herein.

In some embodiments, in the first direction X, the width of the reinforcement part 1413 is greater than or equal to the width of the second body 1412. In the extending direction of the second conductive traces 141, there are two oppositely disposed climbing areas between a second conductive trace 141 and a first conductive trace 121. That is, two sides of the second body 1412 in the second direction Y are respectively connected with a reinforcement part 1413. By setting the width of the reinforcement part 1413 to be larger than the width of the second body 1412, the reinforcement part 1413 can also relieve the over etching of the climbing area and reduce the risk of fracture of the second conductive trace 141.

When the width of the reinforcement part 1413 is equal to the width of the second body 1412, the reinforcement part 1413 and the second body 1412 can be regarded as a whole. The overall structure and the first body 1411 are alternately arranged to form the second conductive traces 141. This design method is helpful for simplifying the structure of the second conductive trace 141, reducing production difficulty, and improving production efficiency.

Secondly, an embodiment of the present application provides a display panel. The display panel includes an array substrate. For the specific structure of the array substrate, refer to the above-mentioned embodiments. The present display panel adopts all the technical solutions of all the above-mentioned embodiments, and therefore at least has all the beneficial effects brought about by the technical solutions of the above-mentioned embodiments, which will not be repeated here.

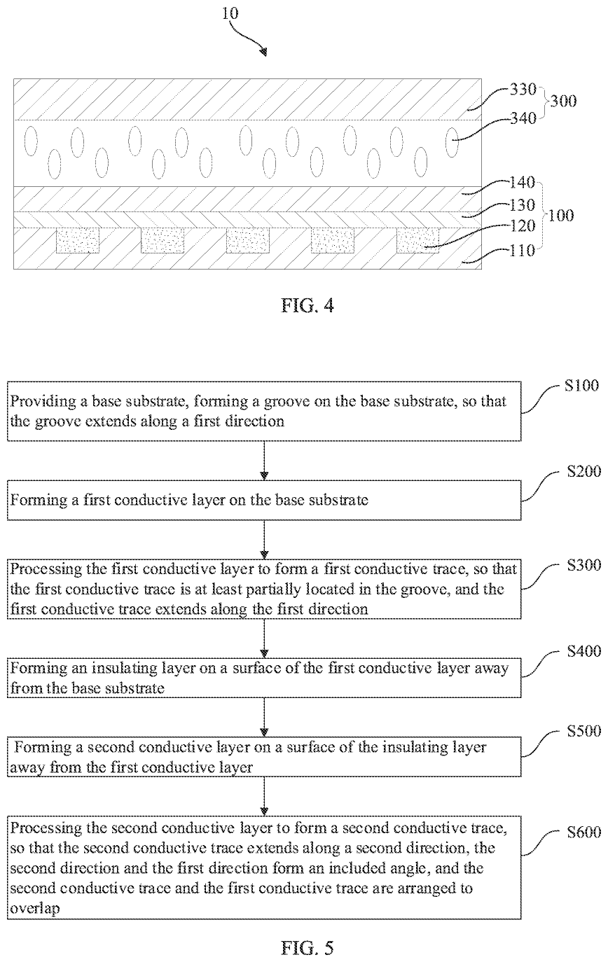

As shown in FIG. 3 and FIG. 4, the display panel 10 includes an array substrate 100 and a display component 300. The display component 300 is located on the side of the array substrate 100 where the second conductive layer 140 faces away from the base substrate 110 in the array substrate 100. The array substrate 100 is mainly used to control a light emitting mode of the display component 300 to adjust a display performance of the display panel 10.

In some embodiments, as shown in FIG. 3, the display component 300 includes a light emitting device 310 and a package assembly 320. The light emitting device 310 is disposed on the side of the second conductive layer 140 in the array substrate 100 away from the base substrate 110 in the array substrate 100. The array substrate 100 is electrically connected to the light emitting device 310 to control a light emitting mode of the light emitting device 310, so as to control an overall display mode of the display panel 10.

The package assembly 320 is disposed on the side of the light emitting device 310 away from the array substrate 100 to protect the light emitting device 310 and the internal structure of the array substrate 100. This prevents external moisture or oxygen from entering and eroding the internal structure of the light emitting device 310 or the array substrate 100, thereby ensuring the overall performance and display performance of the display panel 10.

In other embodiments, as shown in FIG. 4, the display component 300 includes a color filter substrate 330 and a liquid crystal layer 340. The color filter substrate 330 is located on the side of the array substrate 100 where the second conductive layer 140 faces away from the base substrate 110 in the array substrate 100. The color filter substrate 330 is disposed opposite to the array substrate 100. When the display panel 10 is assembled, the array substrate 100 and the color filter substrate 330 are snapped together to form a receiving cavity. The liquid crystal layer 340 is filled in an accommodating cavity between the color filter substrate 330 and the array substrate 100. During the operation of the display panel 10, liquid crystal molecules in the liquid crystal layer 340 are rotated by adjusting a driving signal on the array substrate 100 to change an angle of emitted light and form different display images.

It should be noted that the application range of the display panel 10 in the embodiment of the present application is very wide, including various display and lighting display devices such as televisions, computers, mobile phones, foldable and rollable display screens, and wearable devices such as smart bracelets, smart watches, etc., all fall within the scope of application of the display panel 10 in the embodiment of the present application.

Finally, an embodiment of the present application provides a method for manufacturing an array substrate. As shown in FIG. 5, the method for manufacturing an array substrate mainly includes the following steps:
S100, providing a base substrate 110, forming a groove 111 on the base substrate 110, so that the groove 111 extends along a first direction X.

As shown in FIG. 6 and FIG. 10, when the base substrate 110 is fabricated, the base substrate 110 is first provided, and the base substrate 110 is grooved to form the groove 111 on the base substrate 110. The groove 111 extends along the first direction X. By opening the groove 111 on the base substrate 110, when the subsequent film layer is fabricated on the base substrate 110, the subsequent film layer can be arranged in the groove 111. This reduces the height difference between the subsequent film layer and the base substrate 110.
S200, forming a first conductive layer 120 on the base substrate 110.

After the groove 111 is formed on the base substrate 110, the base substrate 110 is cleaned. Then, the first conductive layer 120 is deposited on the base substrate 110, so that the first conductive layer 120 is partially filled in the groove 111.
S300, processing the first conductive layer 120 to form a first conductive trace 121, so that the first conductive trace 121 is at least partially located in the groove 111, and the first conductive trace 121 extends along the first direction X.

As shown in FIG. 7 and FIG. 8, after the first conductive layer 120 is deposited and formed, the first conductive layer 120 is processed to remove the first conductive layer 120 located on the surface of the base substrate 110 to form the first conductive trace 121, so that the first conductive trace 121 is at least partially located in the groove 111. By at least partially disposing the first conductive trace 121 in the groove 111 of the base substrate 110, the height of the first conductive trace 121 relative to the base substrate 110 is made smaller than the thickness of the first conductive trace 121, thereby reducing the height difference caused by the first conductive trace 121.

The first conductive trace 121 extends along the first direction X. That is, the first conductive trace 121 is filled in the groove 111, so that the arrangement of the groove 111 has a positioning effect on the first conductive trace 121, which is beneficial to improve the structural stability of the first conductive trace 121 relative to the base substrate 110.

It should be noted that, the height difference between the surface of the first conductive trace 121 and the surface of the base substrate 110 can be adjusted according to actual design requirements. It only needs to ensure that the height difference caused by the first conductive trace 121 can be effectively reduced by disposing at least part of the first conductive trace 121 in the groove 111.
S400, forming an insulating layer 130 on a surface of the first conductive layer 120 away from the base substrate 110.

When the first conductive layer 120 is fabricated, the insulating layer 130 needs to be formed on the surface of the first conductive layer 120 away from the base substrate 110, so as to insulate the first conductive layer 120. This facilitates the fabrication of the subsequent film layers and avoids mutual interference between the subsequent film layers and the first conductive layer 120. The insulating layer 130 is disposed on the entire surface, that is, the insulating layer 130 is located on the array substrate 100 and the first conductive trace 121, so as to fully cover the first conductive trace 121, and the risk of interference between the first conductive trace 121 and the subsequent film layers is further reduced.
S500, forming a second conductive layer 140 on a surface of the insulating layer 130 away from the first conductive layer 120.
S600, processing the second conductive layer 140 to form a second conductive trace 141, so that the second conductive trace 141 extends along a second direction Y, the second direction Y and the first direction X form an included angle, and the second conductive trace 141 and the first conductive trace 121 are arranged to overlap.

As shown in FIG. 10 and FIG. 11, after the insulating layer 130 is fabricated, the second conductive layer 140 is deposited on the surface of the insulating layer 130 away from the first conductive layer 120. Then, the second conductive layer 140 is processed so that the second conductive trace 141 extends along the second direction Y. The second direction Y and the first direction X form an included angle, and the second conductive trace 141 and the first conductive trace 121 are arranged to overlap. That is, the first conductive trace 121 and the second conductive trace 141 cross each other in the extending direction, and the first conductive trace 121 and the second conductive trace 141 partially overlap.

When the insulating layer 130 is formed on the first conductive layer 120, the insulating layer 130 is uniformly deposited on the first conductive layer 120. That is, the thickness of the insulating layer 130 is relatively uniform, so that there is a height difference between the part of the insulating layer 130 covering the first conductive trace 121 and the part of the insulating layer 130 not covering the first conductive trace 121. When the second conductive trace 141 is formed on the insulating layer 130, there is a climbing area where the second conductive trace 141 and the first conductive trace 121 overlap. If the climbing height is large, the second conductive trace 141 will be broken.

When forming the first conductive trace 121, the first conductive trace 121 is at least partially disposed in the groove 111 of the base substrate 110. This can effectively reduce the height difference caused by the first conductive trace 121, thereby reducing the climbing height of the climbing area where the second conductive trace 141 and the first conductive trace 121 overlap. Thus, the risk of breakage of the second conductive trace 141 is reduced.

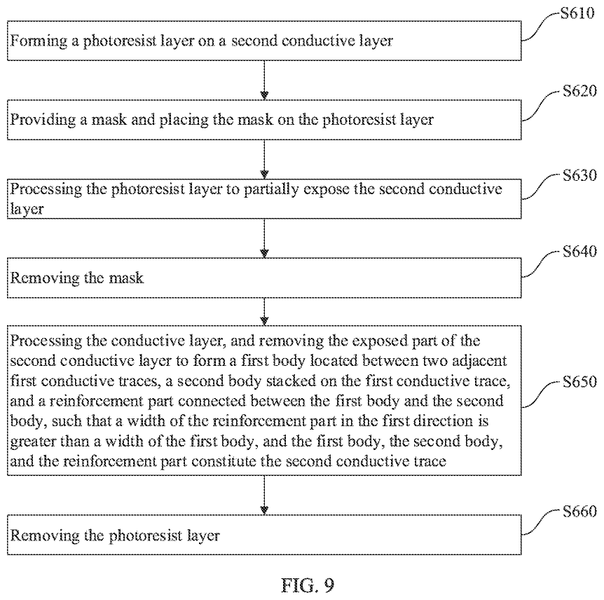

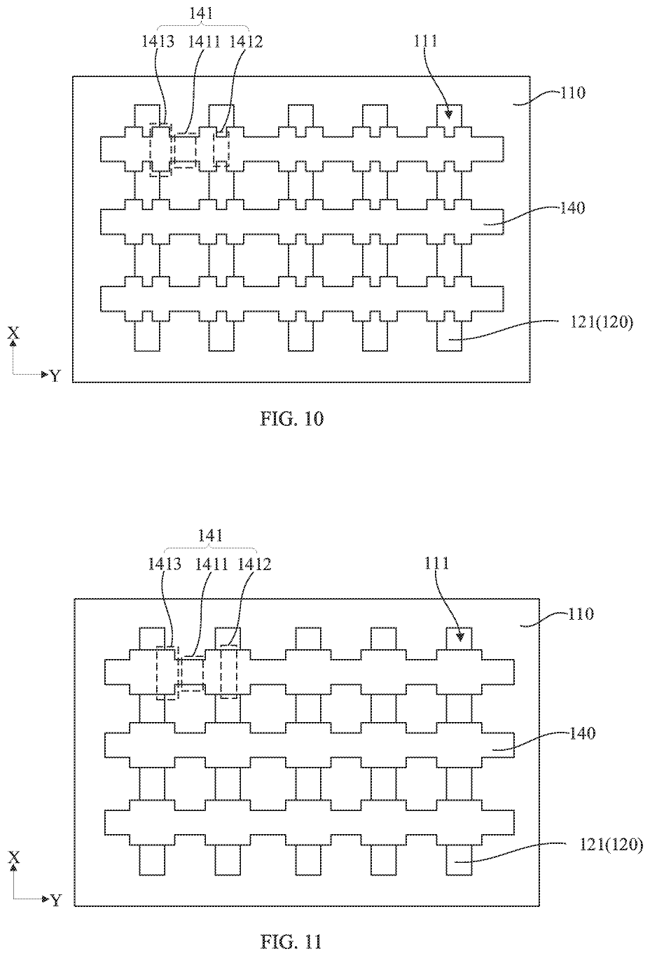

Optionally, as shown in FIG. 9 to FIG. 12, in step S600 of the embodiment of the present application, the second conductive layer 140 is processed to form the second conductive trace 141, which mainly includes the following steps:
S610, forming a photoresist layer on the second conductive layer 140.

Before processing the second conductive layer 140, the photoresist layer is formed on the second conductive layer 140. The photoresist layer is used to protect the second conductive layer 140 to retain a target area of the second conductive layer 140 to form the patterned second conductive layer 140.
S620, providing a mask 200 and placing the mask 200 on the photoresist layer.

When the photoresist layer is processed, part of the photoresist layer needs to be removed and part of the photoresist layer is retained. Therefore, the mask 200 needs to be provided. Through a structural design of the mask 200, a light transmittance of a corresponding area on the mask 200 is controlled, thereby realizing the patterning process of the photoresist layer.
S630, processing the photoresist layer to partially expose the second conductive layer 140.

After the mask 200 is placed, the photoresist layer is exposed to light, and then part of the photoresist layer is removed by developing to partially expose the second conductive layer 140. When the photoresist layer is a forward photoresist, the part exposed to light is removed, and the part not exposed to light remains. When the photoresist layer is a negative photoresist, the part exposed to light is retained, and the part not exposed to light is removed. The patterning process of the photoresist layer can be realized by the mutual cooperation of the type of the photoresist layer and the structure of the mask 200.
S640, removing the mask 200.

After the photoresist layer is patterned, the mask 200 needs to be removed to facilitate subsequent processes.
S650, processing the conductive layer, and removing the exposed part of the second conductive layer 140 to form a first body 1411 located between two adjacent first conductive traces 121, a second body 1412 stacked on the first conductive trace 121, and a reinforcement part 1413 connected between the first body 1411 and the second body 1412, such that a width of the reinforcement part 1413 in the first direction X is greater than a width of the first body 1411, and the first body 1411, the second body 1412, and the reinforcement part 1413 constitute the second conductive trace 141.

As shown in FIG. 10 and FIG. 11, after removing the mask 200, the second conductive layer 140 is etched using the patterned photoresist layer as a template. The exposed part of the second conductive layer 140 is removed, that is, the target pattern of the second conductive layer 140 is kept consistent with the pattern of the photoresist layer. By processing the second conductive layer 140, the first body 1411 located between two adjacent first conductive traces 121, the second body 1412 stacked on the first conductive trace 121, and the reinforcement part 1413 connected between the first body 1411 and the second body 1412 are formed. That is, the first body 1411, the reinforcement part 1413, and the second body 1412 together form the second conductive trace 141 extending along the second direction Y. The reinforcement part 1413 corresponds to the climbing area where the second conductive trace 141 and the first conductive trace 121 overlap.

In the first direction X, the width of the reinforcement part 1413 is greater than the width of the first body 1411. That is, the width of the second conductive trace 141 corresponding to the climbing area is greater than the width of the first body 1411 where the second conductive trace 141 is located between two adjacent first conductive traces 121. The second conductive trace 141 has a climbing height at a position corresponding to the climbing area. When the second conductive layer 140 is patterned to form the second conductive trace 141, over etching is more likely to be formed at the position corresponding to the climbing area. As a result, the second conductive trace 141 is broken in the climbing area. By setting the width of the reinforcement part 1413 to be larger than the width of the first body 1411, a part for over etching can be reserved on the reinforcement part 1413. Therefore, the risk of fracture at the position of the second conductive trace 141 corresponding to the climbing area due to over etching can be effectively prevented.
S660, removing the photoresist layer.

After the fabrication of the second conductive layer 140 is completed, the remaining photoresist layer needs to be peeled off to expose the second conductive trace 141 to facilitate the fabrication of subsequent layers.

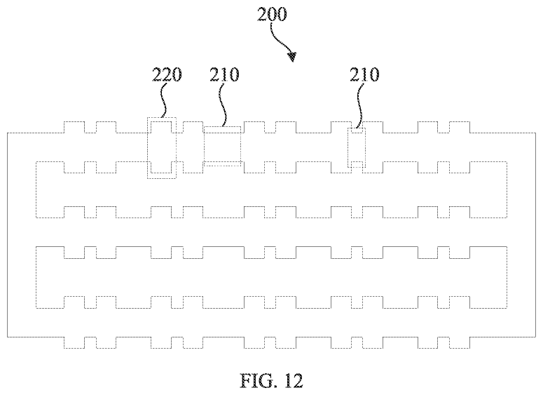

It should be noted that, as shown in FIG. 12, when the photoresist layer used is a forward photoresist, a shielding structure on the mask 200 is consistent with a structure of the second conductive trace 141. That is, the mask 200 includes a first shielding part 210 and a second shielding part 220. The first shielding part 210 corresponds to the first body 1411 and the second body 1412 of the second conductive trace 141. The second shielding part 220 corresponds to the reinforcement part 1413 of the second conductive trace 141, and the width of the second shielding part 220 in the first direction X is greater than the width of the second shielding part 220.

The photoresist layer is patterned by the mask 200, so that the pattern of the photoresist layer is consistent with the target structure of the second conductive traces 141. That is, the width of the area of the patterned photoresist layer corresponding to the reinforcement part 1413 of the second conductive trace 141 is larger than the width of other parts, so as to protect the reinforcement part 1413 of the second conductive trace 141. This prevents the climbing area corresponding to the reinforcement part 1413 from being broken due to over etching when the second conductive layer 140 is etched, so as to ensure the structural stability of the second conductive trace 141.

When the photoresist layer is a negative photoresist, a shielding area on the mask 200 is exchanged with a light transmitting area to ensure that the pattern of the photoresist layer after exposure and development is consistent with the target structure of the second conductive trace 141, and it is not repeated here.

The manufacturing method of an array substrate, a display panel, and an array substrate provided by the embodiments of the present application has been described in detail above. Specific examples are used herein to illustrate the principles and implementations of the present application. The descriptions of the above embodiments are only used to help understand the method and the core idea of the present application. In addition, for those skilled in the art, according to the idea of the present application, there will be changes in the specific embodiments and application scope. In conclusion, the content of this specification should not be construed as a limitation on the present application.

What is claimed is:

1. An array substrate, comprising:
a base substrate, wherein the base substrate is provided with a groove, and the groove extends along a first direction;
a first conductive layer disposed on a surface of the base substrate, wherein the first conductive layer comprises a first conductive trace, the first conductive trace is at least partially located in the groove, and the first conductive trace extends along the first direction;
an insulating layer disposed on a surface of the first conductive layer away from the base substrate;
a second conductive layer disposed on a surface of the insulating layer away from the first conductive layer, wherein the second conductive layer comprises a second conductive trace, and the second conductive trace extends along a second direction; wherein the second direction forms an included angle with the first direction; wherein the second conductive trace and the first conductive trace is arranged overlappingly.

2. The array substrate of claim 1, wherein the base substrate is provided with a plurality of grooves, the grooves are arranged side by side along the second direction; wherein the first conductive layer comprises a plurality of first conductive traces, and the first conductive traces are arranged in a one-to-one correspondence with the grooves.

3. The array substrate of claim 2, wherein the second conductive layer comprises a plurality of the second conductive traces, and the second conductive traces are arranged in parallel along the first direction.

4. The array substrate of claim 1, wherein the first conductive trace comprises a scan line, and the second conductive trace comprises a data line.

5. The array substrate of claim 1, wherein the first conductive trace is all located in the groove; wherein an absolute value of a difference between a thickness of the first conductive trace and a depth of the groove is smaller than a thickness of the first conductive trace.

6. The array substrate of claim 5, wherein a surface of the first conductive trace is flush with the surface of the base substrate.

7. The array substrate of claim 1, wherein a depth of the groove is less than or equal to 15000 angstroms; wherein a width of the groove in the second direction is less than or equal to 100 microns.

8. The array substrate of claim 1, wherein a thickness of the second conductive trace is less than or equal to 15000 angstroms; wherein a width of the second conductive trace in the first direction is less than or equal to 100 microns.

9. The array substrate of claim 3, wherein one of the second conductive traces comprises a first body, a second body, and a reinforcement part, the first body is located between two adjacent first conductive traces, the second body is stacked on one of the first conductive trace, and the reinforcement part is connected between the first body and the second body; wherein in the first direction, a width of the reinforcement part is greater than a width of the first body.

10. The array substrate of claim 9, wherein in the first direction, the reinforcement part protrudes from opposite sides of the first body.

11. The array substrate of claim 9, wherein the width of the reinforcement part is greater than or equal to 1.1 times the width of the first body and less than or equal to 6 times the width of the first body.

12. The array substrate of claim 1, wherein a material of the first conductive traces is same as a material of the second conductive traces; wherein the material of the first conductive traces comprises one or more of molybdenum, aluminum, and copper.

13. A display panel, wherein the display panel comprises an array substrate and a display component; wherein the array substrate comprises:
a base substrate, wherein the base substrate is provided with a groove, and the groove extends along a first direction;
a first conductive layer disposed on a surface of the base substrate, wherein the first conductive layer comprises a first conductive trace, the first conductive trace is at least partially located in the groove, and the first conductive trace extends along the first direction;
an insulating layer disposed on a surface of the first conductive layer away from the base substrate;
a second conductive layer disposed on a surface of the insulating layer away from the first conductive layer, wherein the second conductive layer comprises a second conductive trace, and the second conductive trace extends along a second direction; wherein the second direction forms an included angle with the first direction; wherein the second conductive trace and the first conductive trace is arranged overlappingly;
wherein the display component is located on a side of the second conductive layer away from the base substrate.

14. The display panel of claim 13, wherein the base substrate is provided with a plurality of grooves, the grooves are arranged side by side along the second direction;
wherein the first conductive layer comprises a plurality of first conductive traces, and the first conductive traces are arranged in a one-to-one correspondence with the grooves.

15. The display panel of claim 14, wherein the second conductive layer comprises a plurality of the second conductive traces, and the second conductive traces are arranged in parallel along the first direction.

16. The display panel of claim 13, wherein the first conductive trace is all located in the groove; wherein an absolute value of a difference between a thickness of the first conductive trace and a depth of the groove is smaller than a thickness of the first conductive trace.

17. The display panel of claim 13, wherein a depth of the groove is less than or equal to 15000 angstroms; wherein a width of the groove in the second direction is less than or equal to 100 microns.

18. The display panel of claim 15, wherein one of the second conductive traces comprises a first body, a second body, and a reinforcement part, the first body is located between two adjacent first conductive traces, the second body is stacked on one of the first conductive trace, and the reinforcement part is connected between the first body and the second body; wherein in the first direction, a width of the reinforcement part is greater than a width of the first body.

19. The display panel of claim 13, wherein the display component comprises a light emitting device and a package assembly, the light emitting device is located on a side of the second conductive layer away from the base substrate, and the light emitting device is electrically connected to the array substrate; wherein the package assembly is located on a side of the light emitting device away from the array substrate.

20. The display panel of claim 13, wherein the display component comprises a color filter substrate and a liquid crystal layer, the color filter substrate is located on a side of the second conductive layer away from the base substrate, and the liquid crystal layer is filled between the color filter substrate and the array substrate.
